(19) United States
(12) Patent Application Publication
(10) Pub. No.: US 2010/0259852 A1
(43) Pub. Date: Oct. 14, 2010

(54) Hard disc drive assembly with PCB with IO and read/write connectors on the same end

(75) Inventor: Stephen Ralph Viskochil, Los Gatos, CA (US)

Correspondence Address: SAILE ACKERMAN LLC, 28 DAVIS AVENUE, POUGHKEEPSIE, NY, 12603, US

(73) Assignee: Purpose SAE Magnetics (HK) Ltd.

(21) Appl. No.: 12/386,110

(22) Filed: Apr. 14, 2009

(51) Int. Cl. G11B 5/48; G11B 5/55

(52) U.S. Cl. 360/245.9; 360/264.7; G9B/5.147

(57) ABSTRACT

This device and method provide a hard disc assembly (HDA) printed circuit board (PCB) with the input/output connector and read/write connector on the same end. This allows the printed circuit board for a hard disc assembly to be about 70% smaller and cheaper than the prior art. This device allows for higher data rates and less noise by allowing shorter signal lines between the read/write connector, the integrated circuits and the input/output connector.

### BACKGROUND OF THE INVENTION

1. Field of the Invention

This invention relates to a device and method for controlling hard disc drives. More particularly this invention relates to the shrinking of a hard disc drive printed circuit board (PCB), resulting in improved cost, performance and signal noise.

2. Description of Related Art

In the related art, there is a hard disc assembly (HDA), which includes data storage platters, platter motor, read write heads, voice coil motor, and a hard disc drive controller printed circuit board. The hard disc drive controller printed circuit board (PCB) is used to control the read/write mechanism and the motor that spins the glass, ceramic or aluminum platters, which are coated with magnetic material. The electronics on the PCB also assemble the magnetic domains into bytes for reading and writing data. Underneath the PCB are the connectors for the motor which spins the platters and a filtered vent hole that allows internal and external air pressures to equalize. The board also contains the connector for a high speed linear motor such as a voice coil motor (VCM) 14 which is used to move the read/write arm over the spinning platters 15. As shown in FIG. 1, in the prior art, the input/output (10) connector 11 is on the spindle motor 12 end of the HDA as shown in FIG. 1. The read/write (RW) connector 13 is on the same end as the voice coil motor (VCM) end or left side of the HDA as shown in FIG. 1. The HDA control integrated circuit 16 is shown. Also, in the prior art shown in FIG. 1, there is a large cut-out for the voice coil motor. 17 A size of a typical board as depicted in FIG. 1 is about 97 cm high by 69 cm wide.

In the prior art, the PCB is about the size of a 2.5-inch hard disc assembly, because the 10 connector and the RW connector are on opposite ends of the HDA. In other words, the prior art printed circuit board must be as large as the hard disc assembly, since the 10 connector and read/write connectors are on opposite ends of the HDA. FIG. 1 shows an example prior art PCB whose length and width are 97 cm and 69 cm respectively.

Below are some related prior art.

U.S. Pat. No. 6,644,980 (Kameda) describes a connector structure whereby a hard disc drive is mounted on a substrate without useless open space remaining on the substrate, and allowing miniaturization of the substrate.

U.S. Pat. No. 5,155,662 (I-Shou) discloses a detachable hard disc driver mounting structure, comprising a hard disc drive received inside a sliding case and fastened in a receiving chamber inside a computer mainframe through plug-in connection. I/O pins are made on the hard disc drive at one end for connecting to the mother board of the computer mainframe through an I/O bus line connector.

U.S. Pat. No. 6,875,026 (Lee et al.) describes a connector apparatus of a hard disk drive allows a connector to automatically contact a flexible printed circuit board upon combining a printed circuit board with a head/disk assembly. The connector apparatus includes a printed circuit board with the connector mounted thereon, and a head/disk assembly with the flexible printed circuit board mounted thereon.

### BRIEF SUMMARY OF THE INVENTION

It is the objective of this invention to provide a device and method for controlling hard disc drives.

It is further an objective of this invention provide a device and method to shrink the hard disc drive printed circuit board in order improve price, performance and signal noise.

The objects of this invention are achieved by a hard disc drive assembly (HDA) printed circuit board (PCB) which contains an input/output (IO) connector, a read/write (RW) connector, which is on the same end of said PCB as said IO connector, a voice coil motor (VCM), a hard drive integrated circuit (IC), and a hard drive latch, whose form factor allows the VCM to be placed close to the side of the hard drive assembly (HDA), wherein said hard drive integrated circuit can be placed next to said RW connector and next to said hard drive latch.

### BRIEF DESCRIPTION OF THE DRAWINGS

FIG. 1 shows a hard disc assembly controller printed circuit board top view of the related art.

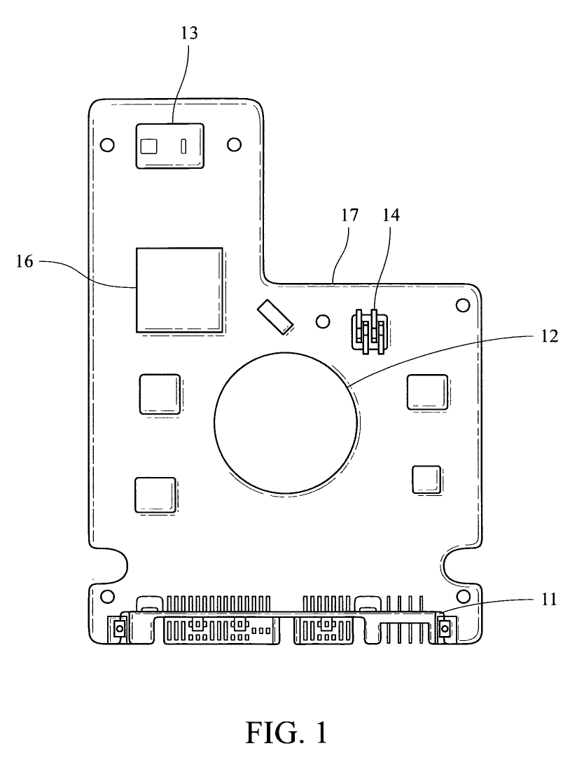

FIG. 2 shows the hard disc assembly controller printed circuit board top view which includes the memory spindle and connectors of the invention.

FIG. 3 shows the hard disc assembly controller printed circuit board bottom view which shows the components on the board of the invention.

### DETAILED DESCRIPTION OF THE INVENTION

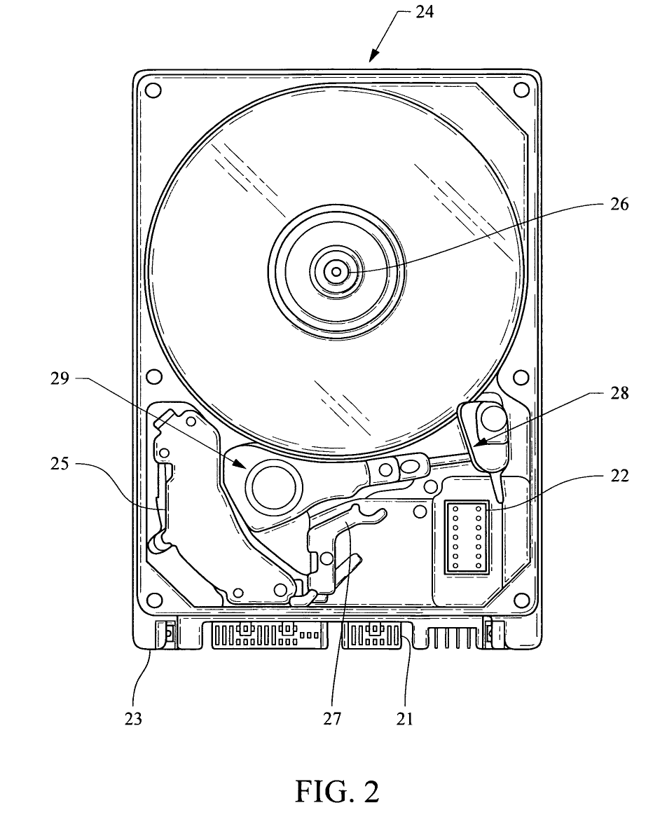

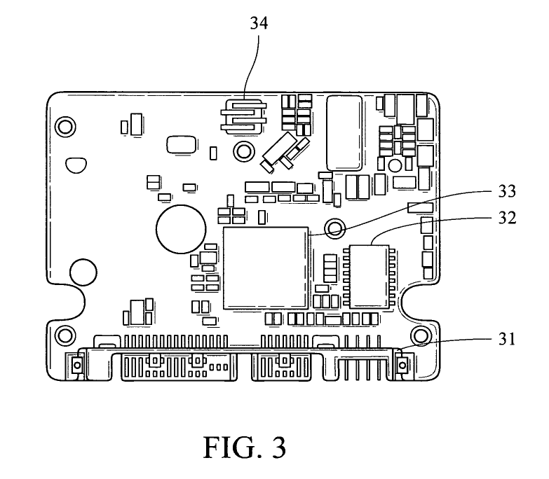

FIG. 2 shows a hard disc assembly (HDA) top view combined with a printed circuit board (PCB), which is on the HDA bottom view shown in FIG. 3. There are 2 ends of the HDA labeled in FIG. 2. The spindle or memory platter end of the HDA is labeled 24. The spindle 26 and memory platter 28 are also shown in FIG. 2. The voice coil motor (VCM) end of the HDA is labeled 23. This new HDA with a PCB which is 40 percent smaller than the prior art is the main embodiment of this invention.

The IO connector 21 is shown in FIG. 2. The relocated read/write (RW) connector 22 is shown in FIG. 2. The new design and placement of the voice coil motor (VCM) 25 allows the VCM to be crowded efficiently into the far-left side of the HDA as shown in FIG. 2. The VCM is designed shorter to allow the PCB to fit underneath and still meet the drive form factor height restriction.

The VCM has been designed to be shorter using many innovative aspects. A single magnet is used on the bottom side of the voice coil, instead of two magnets on the top and bottom side of the voice coil. There are side legs on the steel plates. These side legs help carry the magnetic flux so the plates can be thinner. Since this design uses only one memory platter, there are only two Read/Write heads needed, resulting in less mass. This less mass allows for a thinner coil. All of these items above help to achieve a shorter VCM.

In addition, a hard drive latch 27 is redesigned to allow room to move the VCM closer to the side of the HDA to allow the hard drive IC to fit next to the read/write connector for shorter signal traces. The latch is not on the PCB but inside the HDA.

The inertia latch 27 operates on the Read/Write head 28 side of the actuator pivot 29. The latch is designed to prevent the actuator heads from leaving the ramp and landing on the memory discs. This will cause damage to the heads and disc resulting in data memory loss. When a clockwise rotary shock is applied to the hard disc drive the actuator and Read/Write heads 28 will rotate counter-clockwise. The latch will also rotate counter-clockwise and engage a catch in the actuator preventing the Read/Write heads from going off the ramp onto the memory disc. When a counter-clockwise rotary shock is applied to the hard disc drive the actuator and Read/Write heads will rotate clockwise away from the disc into a soft stop without damage. The prior art uses the same principles but operates on the VCM coil side of the actuator pivot. This requires space on the left side of the VCM which moves the VCM to the right and does not leave enough room for the IC to be close to the Read/Write connector. There is no prior art which has a latch operate on the Read/Write heads side of the actuator pivot.

This new tighter placement of the VCM is the key to allowing the read/write connector 22 to be placed very close to the IO connector 21. The close placement of these 2 connectors is the key to the new smaller PCB shown in FIG. 3. This is the main embodiment of this invention is the compact design and placement of the VCM in FIG. 2.

A cable from the computer plugs into the IO connector and is the means for the computer to talk to the hard disc drive. The Read/Write connector carries the signals from the Read/Write heads and the memory disc to the PCB. The power to the VCM coil also goes through the Read/Write connector. In prior art, the PCB always had a large cut-out for the VCM which would not allow the IO connector to fit on that end. The Read/Write connector needs to be close to the Read/Write heads and the VCM.

FIG. 3 shows the new smaller, improved printed circuit board, which is located on the bottom view of the HDA. It shows the IO connector 31 in close proximity to the read/write connector 32. The control integrated circuit 33 is shown. Also, the voice coil motor connector 34 is shown in FIG. 3. FIG. 3 shows an example PCB which uses the instant application whose width and length can be about 53 cm and 69 cm, respectively. Different dimensions can of course be used without affecting the scope of the invention.

The main advantage of this invention is the new PCB, which is 40% smaller than the prior art. The resultant HDA is much cheaper than the prior art. Also, the smaller PCB allows for shorter signal lines between the read/write connector, the integrated circuit (IC) and the IO connector. The shorter signal lines allow for higher data rates and less head and IO signal noise on the hard disc assembly. This results in a more reliable, higher quality and faster HDA product.

While this invention has been particularly shown and described with Reference to the preferred embodiments thereof, it will be understood by those Skilled in the art that various changes in form and details may be made without Departing from the spirit and scope of this invention.

What is claimed is:

1. A hard disc drive assembly (HDA) printed circuit board (PCB) comprising:
an input/output (IO) connector,
a read/write (RW) connector, which is on the same end of said PCB as said IO connector,
a voice coil motor (VCM),
a hard drive integrated circuit (IC), and
a hard drive latch, whose form factor allows the VCM to be placed close to the side of the hard drive assembly (HDA), wherein said hard drive integrated circuit can be placed next to said RW connector and next to said hard drive latch.

2. The hard disc drive assembly (HDA) printed circuit board (PCB) of claim 1, wherein said PCB can be reduced in size compared to the related art, since said IO connector and said RW connector are on the same end of said PCB.

3. The hard disc drive assembly (HDA) printed circuit board (PCB) of claim 1, wherein said VCM has a small form factor compared to the VCM in the related art, allowing it to fit underneath said PCB and still meet a hard disc drive height restriction.

4. The hard disc drive assembly (HDA) printed circuit board (PCB) of claim 1, wherein said hard disc drive latch is designed to allow placement of said VCM such that said hard disc drive IC can be placed next to said RW connector, for short signal traces.

5. The hard disc drive assembly (HDA) printed circuit board (PCB) of claim 4, wherein said hard disc drive latch is designed to prevent the actuator heads from leaving the ramp and landing on the memory discs, wherein said landing would cause damage to the heads and disc resulting in data memory loss.

6. The hard disc drive assembly (HDA) printed circuit board (PCB) of claim 4, wherein said short signal traces between said HDD IC and said RW connector results in HDA performance and optimum HDA noise immunity improved over the related art.

7. The hard disc drive assembly (HDA) printed circuit board (PCB) of claim 2, wherein said PCB with reduced size results in shorter signal lines among said RW connector, said IC and said IO connector, wherein said shorter signal lines result in higher data rates and less noise than the related art.

8. The hard disc drive assembly (HDA) printed circuit board (PCB) of claim 2, wherein said PCB with reduced size results in a less expensive product than the related art.

9. A method of providing a hard disc drive assembly (HDA) printed circuit board (PCB) comprising the steps of:
providing an input/output (IO) connector,
providing a read/write (RW) connector, which is on the same end of said PCB as said IO connector,
providing a voice coil motor (VCM),
providing a hard drive integrated circuit (IC), and
providing a hard drive latch, whose form factor allows the VCM to be placed close to the side of the hard drive assembly (HDA), wherein said hard drive integrated circuit can be placed next to said RW connector and next to said hard drive latch.

10. The method of providing a hard disc drive assembly (HDA) printed circuit board (PCB) of claim 9, wherein said PCB can be reduced in size compared to the related art, since said IO connector and said RW connector are on the same end of said PCB.

11. The method of providing a hard disc drive assembly (HDA) printed circuit board (PCB) of claim 9, wherein said VCM has a small form factor compared to the VCM in the related art, allowing it to fit underneath said PCB and still meet a hard disc drive height restriction.

12. The method of providing a hard disc drive assembly (HDA) printed circuit board (PCB) of claim 9, wherein said hard disc drive latch is designed to allow placement of said VCM such that said hard disc drive IC can be placed next to said RW connector, for short signal traces.

13. The method of providing a hard disc drive assembly (HDA) printed circuit board (PCB) of claim 12, wherein said hard disc drive latch is designed to prevent the actuator heads from leaving the ramp and landing on the memory discs, wherein said landing would cause damage to the heads and disc resulting in data memory loss.

14. The method of providing a hard disc drive assembly (HDA) printed circuit board (PCB) of claim 12, wherein said short signal traces between said HDD IC and said RW connector results in HDA performance and optimum HDA noise immunity improved over the related art.

15. The method of providing a hard disc drive assembly (HDA) printed circuit board (PCB) of claim 10, wherein said PCB with reduced size results in shorter signal lines among said RW connector, said IC and said IO connector, wherein said shorter signal lines result in higher data rates and less noise than the related art.

16. The method of providing a hard disc drive assembly (HDA) printed circuit board (PCB) of claim 10, wherein said PCB with reduced size results in a less expensive product than the related art.
